(19) United States
(12) Patent Application Publication
(10) Pub. No.: US 2010/0017697 A1
(43) Pub. Date: Jan. 21, 2010

(54) DATA ADMINISTRATION SYSTEM AND PICTURE INSERT METHOD THEREOF

(76) Inventor: Ting-Ying LEE, Taipei City (TW)

Correspondence Address: BRIAN M. MCINNIS, 12th Floor, Ruttonjee House, 11 Duddell Street, Hong Kong, HK

(21) Appl. No.: 12/202,898

(22) Filed: Sep. 2, 2008

(30) Foreign Application Priority Data
Jul. 17, 2008 (TW) 97127202

(51) Int. Cl. G06F 17/30; G06F 17/00

(52) U.S. Cl. 715/208; 707/1; 715/255; 707/E17.031

(57) ABSTRACT

A data administration system includes a database having files, at least a data sheet having at least an appointed field and at least a picture paste field, wherein each picture file has a picture and an identical filename. The user may input one filename on the data filed. The data administration system further includes a selection module operable for selecting the file with the inputted filename from the database, and a picture paste module operable for pasting the picture of the selected file on the picture paste field.

### RELATED APPLICATIONS

This application claims priority to Taiwan Application Serial Number 97127202, filed Jul. 17, 2008, which is herein incorporated by reference.

### BACKGROUND

1. Field of Invention

The present invention relates to data administration methods. More particularly, the present invention relates to inserting pictures in a document.

2. Description of Related Art

Nowadays, computer software has become necessary when dealing with data or documents. Word processing software and database administration systems help users work on documents like official documents, reports, album, or poster.

Manufacturers also rely on word processing software and database administration system to complete all kinds of documents. Although word processing software is very popular and convenient in some ways, the word processing software still has many awkward problems needed to be solved. Take a test report as an example. When processing a test report, the user may use word processing software to create a framework for a report. Then, the user may key in measurement results, for example measurement data, or pictures like data plot, or photos on the framework. The user may need to adjust or edit the format of the pictures, and input some information about the pictures like the name of the pictures, the dates, or the preformed experiment etc. Each report may contain many pictures, from one to hundreds of pictures, hence the user has to repeat the above steps hundreds of times to complete just one report. To repeat the same movement several times wastes time. Also, during such routine work, the user may miss and input wrong pictures easily.

Therefore, new word processing and data administrating method and system thereof are needed to overcome the default of the old word processing software, to reduce the negligence of the user, and furthermore, to shorten the processing time.

### SUMMARY

A data administration system is provided. The data administration system may help dealing with routine picture inserting process. The data administration system contains a database and at least a sheet. The database has a plurality of files, wherein each file has a picture and a filename different from the filenames of other files. The sheet has at least an appointed field and at least a picture paste field. A user may input a filename in the appointed field.

The data administration system further has a selection module to select the file with the filename the same as the filename inputted in the appointed field from the database. A picture paste module of the data administration system may paste the picture of the selected file on the picture paste field.

In the foregoing, the user may input those filenames on the appointed fields in the sheet, the data administration system may automatically pick the corresponding pictures from the database and may paste the pictures on the desired place. The user doesn't need to waste time and effort on searching the pictures and repeating pasting pictures.

The invention also provides a data administration system to help processing documents with amount of pictures quickly to prevent the negligence of humans doing boring routine work.

The data administration system contains a database and sheets. The database has a plurality of files, wherein each file has a picture and a filename different from the filenames of other files. A first sheet has at least an appointed field for inputting the filename and a hyperlink field. A second sheet has at least a picture paste field.

After the user inputs a filename in the appointed field, a selection module of the data administration system may select the file with the filename the same as the inputted filename in the appointed field from the database. And then, a picture paste module of the data administration system may paste the picture of the selected file on the picture paste field. A hyperlink module may then establish a hyperlink on the hyperlink field linked to the picture paste field. Therefore, the user may use the hyperlink on the first sheet linking to the picture on the second sheet.

In other words, the data administration system may help picking pictures and pasting pictures on the picture paste field as long as the user established a proper database and inputs the correct filenames in the appointed fields. The user may save time and reduce some human negligence.

In addition, the invention discloses a picture insert method to insert pictures in at least a sheet, which may help the user to quickly complete documents with many pictures. The picture insert method comprises several steps as follows.

First, a plurality of files may be stored in a database, wherein each file has a picture and a filename different from other files. Then, the user may input the filename in at least an appointed field in a first sheet. Then, the file with the filename the same as the filename inputted in the appointed field may be selected from the database. And the picture of the selected file may be pasted on at least a picture paste field in a second sheet. Finally, the format of the picture pasted on the picture paste field may be edited.

In the foregoing, the picture insert method may help the user find, paste and edit pictures, which may not only save time but also prevent possible errors due to negligence.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a data administration system according to an embodiment of this invention;

FIG. 2A is a front view of a sheet before the data administration system operated according to one embodiment of this invention;

FIG. 2B is a front view of the sheet after the data administration system operated;

FIG. 3 is a block diagram of a data administration system according to another embodiment of this invention;

FIG. 4A is a front view of a first sheet before the data administration system operated according to another embodiment of this invention;

FIG. 4B is a front view of a second sheet before the data administration system operated according to another embodiment of this invention;

FIG. 5A is a front view of the first sheet shown in FIG. 4A after the data administration system operated;

FIG. 5B is a front view of the second sheet shown in FIG. 4B after the data administration system operated; and

FIG. 6 is a flow chart of picture insert method according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

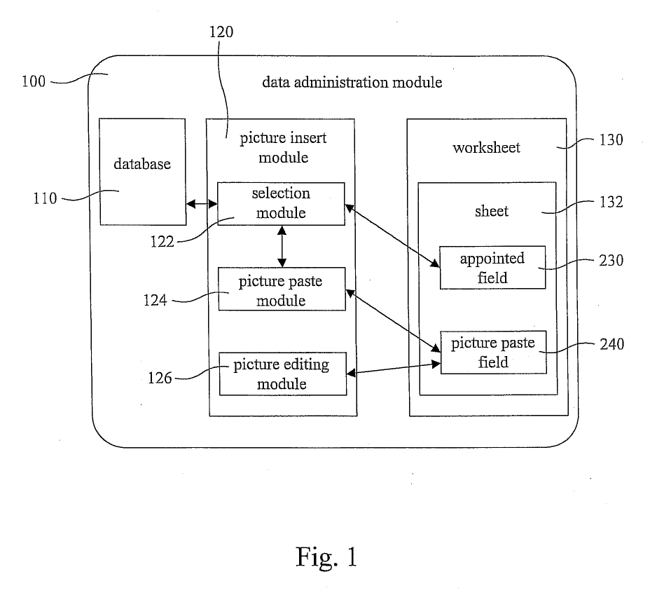

Please refer to FIG. 1, which is a block diagram of a data administration system 100 according to an embodiment of this invention. The data administration system 100 includes a database 110, a picture insert module 120, and a worksheet 130. The picture insert module 120 contains many sub modules to help deal with routine work, for example searching pictures, pasting, and editing format of pictures etc. The worksheet 130 may have at least one sheet 132 to help processing calculation or statistics. In the embodiment of this invention, the worksheet 130 has a sheet 132.

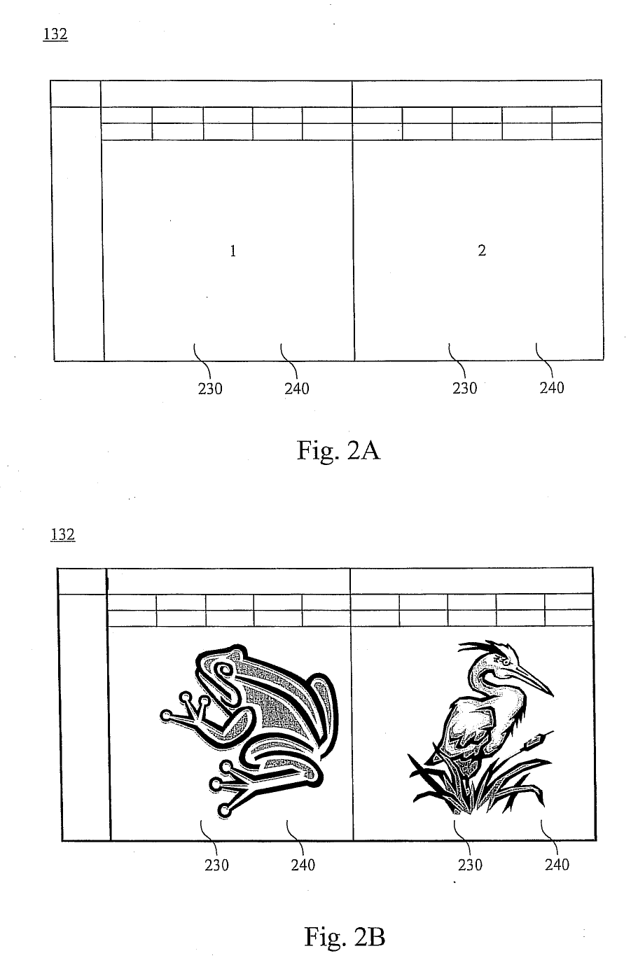

Please refer to FIG. 1, FIG. 2A, and FIG. 2B. FIG. 2A is a front view of the sheet 132 before the data administration system 100 operated according to one embodiment of this invention. FIG. 2B is a front view of the sheet 132 after the data administration system 100 operated.

The database 110 stores a large amount of files. Each file has a picture and an individual filename. The filename of each file is different from the filenames of other files. It is noteworthy that the database 110 in the embodiment of this invention represents all kind of storage or programs, which may store files, such as memory, compact disks, or folders.

The sheet 132 has appointed fields 230, which may allow the user to input the filename of one of the files, and picture paste fields 240, which may allow pictures to be pasted on. The sheet 132 contains several columns and rows. The appointed field 230 and the corresponding picture paste field 240 are disposed in the same row. In the embodiment of this invention, the appointed field 230 and the corresponding picture paste field 240 are disposed in the same row and the same column.

After the user input filenames in the appointed fields 230, a selection module 122 of the picture insert module 120 may select the file from the database 110 according to the inputted filename. Specifically, the selection module 122 may select the file with the filename the same as the inputted filename in the appointed field 230 from the database 110. As the above, each file in the database 110 has an individual filename, and every filename only represents one file. Therefore, as long as the user inputs the correct filename, the selection module 122 will pick up the correct file with no errors.

After selecting the file, a picture paste module 124 of the picture insert module 120 may paste the picture of the selected file on the picture paste field 240 on the sheet 132. As the above, since each file only contains one picture, the pasting the wrong picture can be prevented.

In the embodiment of this invention, the picture insert module 120 further includes a picture edit module 126 operable for editing format of pictures. Specifically, the picture edit module 126 may edit the format of the picture pasted on the picture paste field 240, such as image size, lighting, color, contrast, or resolution.

In the embodiment of this invention, the picture edit module 126 may adjust the size of the picture to fit in the picture paste field 240. Those skilled in the art know many ways can be applied to change the size of pictures. The picture edit module 126 of the embodiment changes the display size of picture by changing the resolution of the picture.

In the foregoing, the user just needs to store files with individual filenames in the database 110, and to input the correct filenames in the appointed fields 230. The data administration module 100 may paste the corresponding pictures on the desired places, the picture paste fields 240, and may adjust the format of every pasted picture automatically. The user doesn't need to do the above routine work, which may speed up the process, and may prevent the user selecting the wrong picture during the routine work.

In the sheet 132 of the embodiment, filenames and pictures are shown on the same sheet 132. In another embodiment of this invention, filenames and the corresponding picture may be shown on different sheets 132.

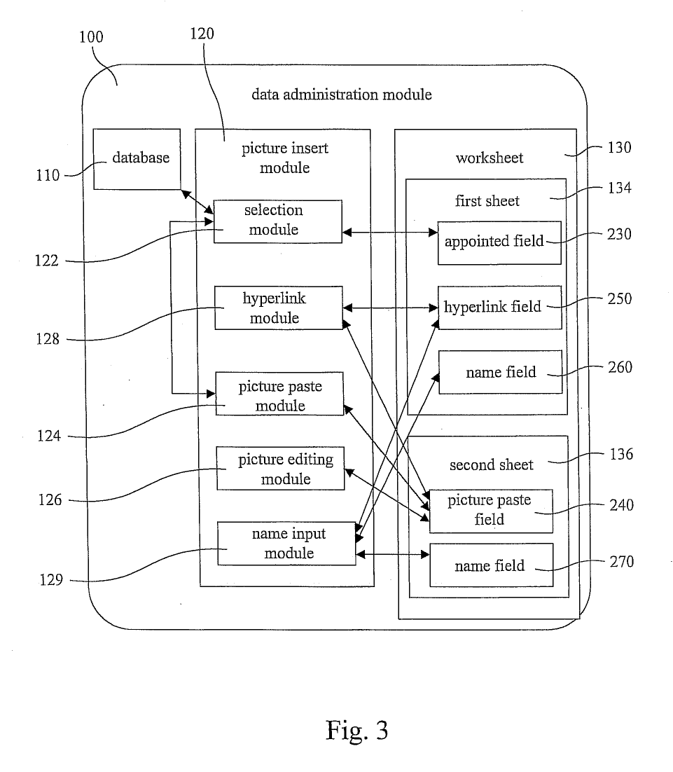

Please refer to FIG. 3, which is a block diagram of a data administration system 100 according to another embodiment of this invention. The worksheet 130 of the data administration system 100 has a first sheet 134 and a second sheet 136. Please notice that the first sheet 134 and a second sheet 136 mentioned here as an example, the number of the sheets in the worksheet 130 is not limited. In fact, the number of the sheets in the worksheet 130 can be many, and the displacement of sheets can be various.

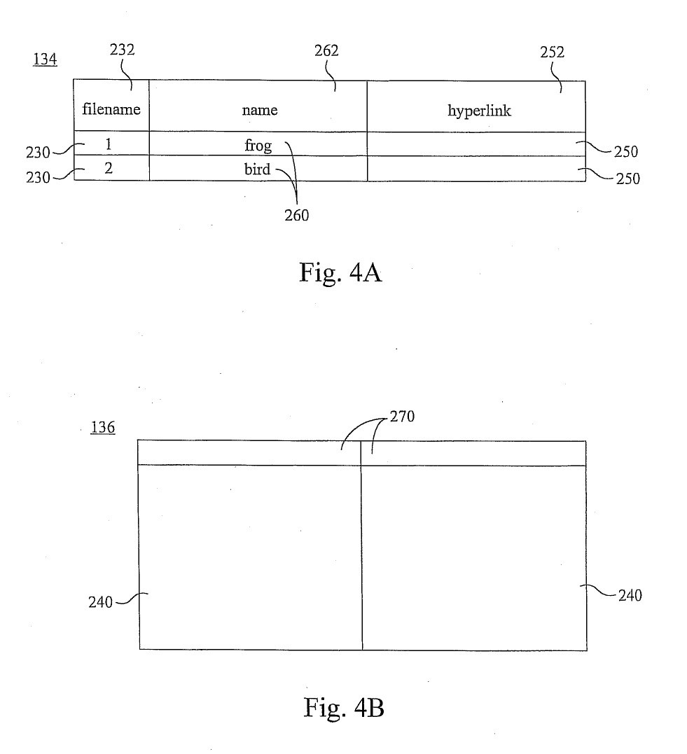

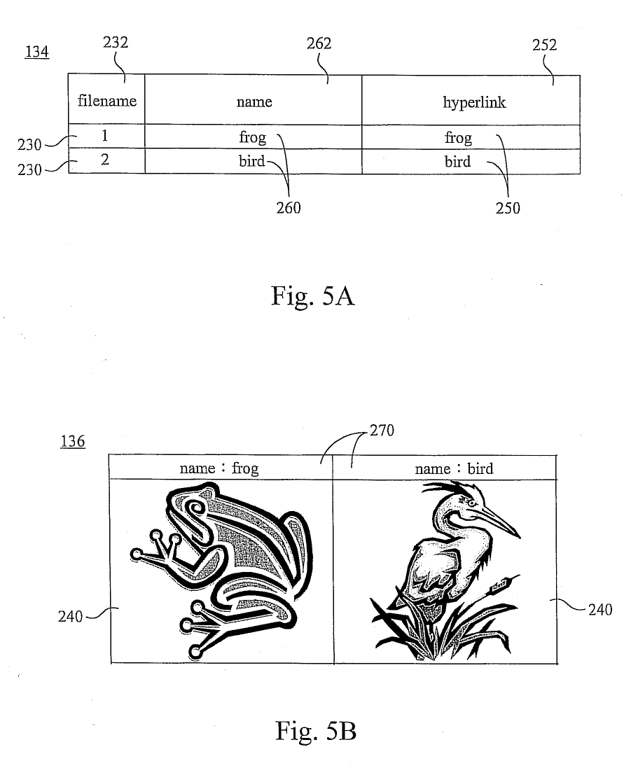

FIG. 4A and FIG. 4B show a front view of a first sheet 134 and a second sheet 136 before the picture insert module 120 operated according to another embodiment of this invention. FIG. 5A and FIG. 5B show a front view of the first sheet 134 and the second sheet 136 after the picture insert module 120 operated.

Please refer to FIG. 3 to FIG. 5B. The first sheet 134 has the appointed fields 230 for the user to input filenames. The second sheet 136 has the picture paste fields for pictures pasted on.

After the user inputs filenames on the appointed fields 230, the selection module 122 of the picture insert module 120 may find out the files from the database 110 according to the inputted filenames. In other words, the selection module 122 may select the files, which have the filenames the same as those filenames inputted on the appointed field 230, from the database 110. The picture paste module 124 of the picture insert module 120 may paste the picture of each of the selected files on the picture paste fields 240 in the second sheet 136.

The first sheet 134 further has hyperlink fields 250 disposed immediately next to the appointed fields 230. Those skilled in the art know that the hyperlink is a navigation tool, which may be set at a section of a document and may link to another section of the document or another document. The picture insert module 120 of the embodiment has a hyperlink module 128 operable for establishing hyperlinks linked to the picture paste fields 240 on the hyperlink fields 250. Therefore, each hyperlink field 250 disposed in the first sheet 134 may have a hyperlink linked to the corresponding picture paste field 240 in the second sheet 136. It is convenient that when the user clicks the hyperlink field 250 next to the appointed field 230, the picture on the picture paste field 240 will be shown.

In the embodiment of this invention, the picture insert module 120 further includes a picture edit module 126 operable for editing format of the pictures pasted on the picture paste fields 240 in the second sheet 136. The user may preset the display format of the picture. Then, the picture edit module 126 may edit every pictures on the second sheet 136 according the preset format.

As the above, the picture edit module 126 may change image size, lighting, color, contrast, or image resolution, etc. In the embodiment of this invention, the picture edit module 126 changes the resolution of the pictures.

In the embodiment of this invention, the first sheet 134 further comprises name fields 260 immediately next to the appointed fields 230. The user may input information about the pictures like name, date, or measurement process etc. on the name fields 260. The second sheet 136 also has name fields 270 immediately next to the picture paste fields 240. The name fields 270 may show the same word as the name fields 260.

Those words on the name fields 260 and the name fields 270 may be inputted by the user or by the picture insert module 120. Specifically, the picture insert module 120 includes a name input module 129 operable for copying the context of the name field 260 in the first sheet 134, and pasting the context on the name field 270 in the second sheet 136.

In addition, the name input module 129 may copy the context of each name field 260 and paste it on the corresponding hyperlink field 250 as hypertext. In other words, the hyperlink fields 250 may have hyperlink linking to the picture paste fields 240 in the second sheet 136. And the context of the hyperlink fields 250, also refer to as hypertext, is the same as the context of the name fields 260.

The first sheet 134 has many rows and columns. In general, related data often shows in the same rows. Therefore, in the embodiment of this invention, the appointed field 230 and the corresponding name field 260 and the hyperlink field 250 are disposed in the same rows.

Furthermore, the displacement of the appointed fields 230, the name fields 260 and the hyperlink fields 250 may be set with some rules. In fact, the appointed fields are disposed in the same column in the embodiment of this invention. In addition, the column, which has the appointed fields, further includes a mark field 232 disposed therein. The mark field 232 may input some special key words like “filename” or “file”. When the selection module 122 operates, the selection module 122 may first search through the first sheet 134 to find out which field has the key word and treat it as the mark field 232. And then, the selection module 122 may locate the column having the mark field 232 and take every field in the column as the appointed fields 230.

Similarly, the name fields 260 and a mark field 262 are disposed in the same column, wherein the mark field 262 may help the name input module 129 to locate the name fields 260. The hyperlink fields 250 and a mark field 252 are disposed in the same column, too. The mark field 252 may also help the hyperlink module 128 to locate the hyperlink fields 250.

The second sheet 136 has many rows and columns as well. In the embodiment of this invention, the name fields 270 and the corresponding picture paste fields 240 are disposed in the same column.

In the foregoing, the data administration system 100 and the picture insert module 120 thereof may help word processing, especially when processing document with amount of pictures. The user only needs to establish a proper framework of the worksheet 130, store files in the database 110, and input right filenames on the appointed fields 230 and right information on the name fields 260. The picture insert module 120 of data administration system 100 may automatically pick the corresponding pictures from the database 100, paste the pictures on the desired picture paste fields 240, edit the format of the pasted picture, and paste the context of the name fields 260 on the name fields 270 and the hyperlink fields 250.

The user doesn't need to waste time and effort searching for pictures or copying and pasting pictures repeatedly, which may save the user's time and energy.

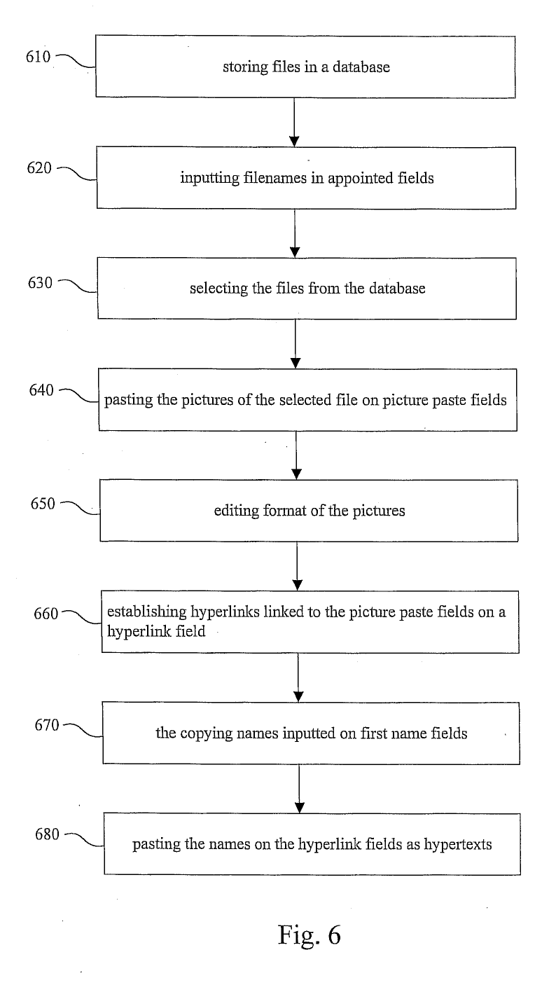

Refer to FIG. 6. FIG. 6 is a flow chart of the picture insert method 600 according to another embodiment of this invention. The picture insert method 600 may help the user to complete documents with a large amount of pictures quickly. The picture insert method 600 comprises several steps as follows. It is noteworthy that the order of steps of the picture insert method 600 is not limited by the following description.

In the first step 610 of the picture insert method 600, a plurality of files may be stored in a database, wherein each file has a picture and a filename different from other files. Next, in the step 620, a filename is inputted in at least one appointed field in a first sheet. As the above, the user inputs the filename of the files in the database on the appointed fields.

Then, in step 630, the file with the filename the same as the filename inputted in the appointed field is selected from the database. As the above, each file in the database 110 has an individual filename, and every filename only represents one file. Therefore, the selection module 122 will not pick up incorrect files as long as the user inputs the correct filenames. Then, in step 640, the picture of the selected file may be pasted on at least a picture paste field in a second sheet.

In step 650, format of the pictures pasted on the picture paste fields may be edited to fit the display format of the picture paste fields. Specifically, the format of the picture may be the size, lighting, color, contrast, or resolution etc. In the embodiment of this invention, the size of the picture may be changed by adjusting the resolution of the picture.

Because there may be many sheets in the embodiment of this invention, it will be convenient to compare the context of sheets when reading. Therefore, the picture insert module 600 further includes step 660 to establish hyperlinks linked to the second sheet on at least a hyperlink field in the first sheet. Specifically, in step 660, the uniform resource locator, refer to as URL, of the picture paste fields in the second sheet may be inputted on the hyperlink field in the first sheet. The hyperlink field and the corresponding appointed field are disposed in the same row in the first sheet.

Generally, information like names shown beside data like the pictures may help readers to understand the data. In addition, information about the same event may spread out in many sheets of a document, and therefore, name or hyperlink may help the reader find the information. The picture insert method 600 of the embodiment further includes labeling related information through out the entire document.

Specifically, the user may input a name on a first name field in the first sheet. In the embodiment of this invention, the first name field and the appointed field are disposed in the same row. In step 670, the name inputted on the first name field in the first sheet may be copied.

In step 680, the name may be pasted on the hyperlink field as hypertext. The context of the hyperlink field is called hypertext, wherein the hypertext copied from the context of the first name field.

In the embodiment, the picture insert method further pastes the copied name on a second name field immediate next to the picture paste field in the second sheet, which may help the user and the readers to identify pictures.

The second name field is disposed right next to the corresponding picture paste field in the second sheet. The second name field and the corresponding picture paste field may be disposed on two adjacent fields in the same row, or disposed on two adjacent fields in the same column.

In the foregoing, the picture insert method 600 may help the user doing routine work like finding, pasting and editing pictures, which may not only save time but also prevent some possible negligent during those routine works.

Although the present invention has been described in considerable detail with reference t certain embodiments thereof, other embodiments are possible. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A data administration system, comprising:
a database having a plurality of files, wherein each file has a picture and a unique filename different from the filenames of other files;
at least a sheet having at least an appointed field for inputting the filename and at least a picture paste field;
a selection module operable for selecting the file with the filename inputted in the appointed field from the database; and
a picture paste module operable for pasting the picture of the selected file on the picture paste field.

2. The data administration system of claim 1, further comprising a picture edit module operable for editing the format of the picture pasted on the picture paste field.

3. The data administration system of claim 2, wherein the format of the picture is image resolution.

4. The data administration system of claim 1, wherein the sheet comprises a plurality of columns and rows, wherein the appointed field and the picture paste field disposed on the same row.

5. The data administration system of claim 4, wherein the appointed field and the picture paste field disposed on the same column.

6. A data administration system, comprising:
a database having a plurality of files, wherein each file has a picture and a filename different from the filenames of other files;
a first sheet having at least an appointed field for inputting the filename and a hyperlink field;
a second sheet having at least a picture paste field;
a selection module operable for selecting the file with the filename inputted in the appointed field from the database;
a picture paste module operable for pasting the picture of the selected file on the picture paste field; and
a hyperlink module operable for establishing a hyperlink linked to the picture paste field on the hyperlink field.

7. The data administration system of claim 6, further comprising a picture edit module operable for editing the format of the picture pasted on the picture paste field.

8. The data administration system of claim 7, wherein the format of the picture is the image resolution.

9. The data administration system of claim 6, wherein the first sheet further comprises at least a first name field for inputting a name.

10. The data administration system of claim 9, wherein the second sheet further comprises at least a second name field immediately next to the picture paste field.

11. The data administration system of claim 10, further comprising a name input module operable for copying the name inputted on the first name field, pasting the name on the hyperlink field as a hypertext, and pasting the name on the second name field.

12. The data administration system of claim 10, wherein the second sheet further comprises a plurality of columns and rows, wherein the second name field and the picture paste field are disposed on the same row.

13. The data administration system of claim 9, wherein the first sheet further comprises a plurality of columns and rows, wherein the appointed field, the first name field and the hyperlink field are disposed on the same row.

14. A picture insert method for inserting a plurality of pictures in at least a sheet, the picture insert method comprising:
storing a plurality of files in a database, wherein each file has a picture and a filename different from other files;
inputting the filename on at least an appointed field in a first sheet;
selecting the file with the filename inputted in the appointed field from the database;
pasting the picture of the selected file on at least a picture paste field in a second sheet; and
editing the format of the picture pasted on the picture paste field.

15. The picture insert method of claim 14, after the step of pasting the picture on the picture paste field further comprising:
establishing a hyperlink linked to the picture paste field on at least a hyperlink field in the first sheet.

16. The picture insert method of claim 15, wherein the first sheet comprises a plurality of columns and rows, wherein the appointed field and the hyperlink field are disposed on the same row.

17. The picture insert method of claim 15, further comprising:
copying a name inputted on a first name field in the first sheet; and
pasting the name on the hyperlink field as a hypertext.

18. The picture insert method of claim 17, further comprising:
pasting the name on a second name field immediate next to the picture paste field on the second field.

19. The picture insert method of claim 18, wherein the second sheet comprises a plurality of columns and rows, wherein the second name field and the picture paste field are disposed on the same row.
